(19) United States
(12) Patent Application Publication
(10) Pub. No.: US 2008/0060056 A1
(43) Pub. Date: Mar. 6, 2008

(54) MULTI-SERVICE PROCESS MANAGEMENT SYSTEM AND METHOD

(75) Inventors: Feng Li, Shenzhen (CN); Jun Zhang, Shenzhen (CN)

Correspondence Address: AKIN GUMP STRAUSS HAUER & FELD, LLP, P O BOX 688, DALLAS, TX, 75313-0688, US

(73) Assignee: Huawei Technologies Co., LTD., Shenzhen Guangdong Province (CN)

(21) Appl. No.: 11/849,606

(22) Filed: Sep. 4, 2007

(30) Foreign Application Priority Data
Sep. 4, 2006 (CN) 200610037435.9

(51) Int. Cl. G06F 15/16

(52) U.S. Cl. 726/3

(57) ABSTRACT

A multi-service-process management system and method are disclosed. The system is in C/S architecture, and including a client having multiple sub-service client processes and a server having multiple sub-service server processes corresponding to the multiple sub-service client processes. The client includes at least one process managing unit managing a group of sub-service client processes centrally. The process managing unit includes an authentication information managing module, used to input authentication information required for the group of the sub-service client processes managed by the process managing unit to log on the server and manage the authentication information; a centralized process managing module, used to control the group of the sub-service client processes to obtain the authentication information, log on the server for carrying out authentication and connect to the sub-service server processes, and manage run state of the group of the sub-service client processes centrally.

This application claims priority to Chinese Application No. 200610037435.9, filed on Sep. 4, 2006 and entitled “Multi-Service-Process Management System and Method”, content of which is incorporated herein by reference in its entirety.

### FIELD OF THE INVENTION

The present invention relates to process management technique in information management field, particularly to a multi-service-process management system and a multi-service-process management method in C/S architecture.

### BACKGROUND OF THE INVENTION

As the developing of information technologies and the growing of information processing services, information systems become larger and larger, and the information processing load on computers becomes heavier and heavier. In order to improve information processing speed and flexibility of an information system, information management systems in Client/Server (C/S) architecture have emerged. In such an information management system, different tasks are handled by clients before being submitted to a server, so as to take full advantage of the information processing capability of the clients.

For the convenience of application and management, in an information system in C/S architecture, a user usually categorizes the information (or services) by nature, purpose and type, so as to allocate the information processed by the information system to multiple service subsystems for management. In the information system in C/S architecture as shown in FIG. 1, a client 110 has multiple sub-service client processes 111, and a server 120 has multiple sub-service server processes 121 corresponding to the sub-service client processes 111. After each sub-service client process 111 of the client 110 starts up, the sub-service client process 111 prompts the user to input a user name, a password, an IP address of the server to be logged on and the like, connects to the server 120 and passes the privilege verification in an authenticating unit 122, and then the sub-service client process 111 may log on the server 120 and connect to a corresponding sub-service server process 121 for information communication.

However, in the application and management procedures, an information system in C/S architecture has the following issues.

1. Since there are multiple sub-service processes in the information system, when each sub-service client process logs on the server, the user is required to input a user name, a password and an IP address of the server to be logged on, thus bringing severe inconvenience to the user of the information system;

2. The user is required to perform control operations such as log-off, lock/unlock, exit, separately for each sub-service client process on the client. Therefore, the operations are complex and difficult to be managed.

### SUMMARY OF THE INVENTION

The present invention is to provide a multi-service-process management system and a multi-service-process management method, so as to centrally manage multiple sub-service client processes in a client, simplify management and operations of the system, and improve operation efficiency of the system.

To overcome above issues, the present invention discloses a multi-service-process management system, being constructed in C/S architecture, and including a client having multiple sub-service client processes and a server having multiple sub-service server processes corresponding to the multiple sub-service client processes, wherein the client includes at least one process managing unit that manages centrally a group of sub-service client processes, and the process managing unit includes:

an authentication information managing module, used to input authentication information required for the group of the sub-service client processes managed by the process managing unit to log on the server, and manage the authentication information;

a centralized process managing module, used to control the group of the sub-service client processes to obtain the authentication information, log on the server for carrying out authentication and connect to the corresponding sub-service server processes on the server, and manage run state of the group of the sub-service client processes centrally.

The centralized process managing module includes:

a process start controlling sub-module, used to control the group of the sub-service client processes to start and control the group of the sub-service client processes to obtain the authentication information and log on the server for carrying out the authentication;

a centralized process controlling sub-module, used to create a process state control command and control the run state of the group of the sub-service client processes centrally;

a command issuing sub-module, used to issue the process state control command to the group of the sub-service client processes, such that the group of the sub-service client processes may receive and execute the process state control command.

Preferably, the centralized process managing module further includes:

a process state recording sub-module, used to record the run state of the group of the sub-service client processes, such that the centralized process controlling sub-module may maintain the run state of the group of the sub-service client processes according to a recording result.

The authentication information managing module includes:

an authentication information inputting sub-module, used to input the authentication information required for the group of the sub-service client processes managed by the process managing unit to log on the server;

an authentication information managing sub-module, used to manage the authentication information inputted from the authentication information inputting sub-module such that the authentication information may be obtained only by the group of the sub-service client processes.

Preferably, the authentication information managing sub-module is a storage unit that may be accessed by the group of the sub-service client processes exclusively or a shared memory of the client.

The authentication information managing module further includes:

an authentication information verifying sub-module, used to verify the authentication information by logging on the server with the authentication information inputted from the authentication information inputting sub-module.

The authentication information includes a user name and a password required for the group of the sub-service client processes managed by the process managing unit to log on the server, as well as process key flag information determining whether the group of the sub-service client processes is to connect to the corresponding sub-service server processes on the server automatically after the group of the sub-service client processes log on the server.

Accordingly, the present invention also discloses a multi-service-process management method, for managing the service processes in C/S architecture. The method manages a group of sub-service client processes on a client centrally and includes:

inputting from the client authentication information required for the group of the sub-service client processes managed by the client to log on a server from the client, and managing the inputted authentication information;

controlling, by the client, the group of the sub-service client processes centrally to obtain the inputted authentication information, then logging on the server for carrying out authentication, connecting to corresponding sub-service server processes on the server, and managing run state of the group of the sub-service client processes centrally.

After inputting from the client the authentication information, the method further includes:

logging on, by the client, the server with the inputted authentication information to verify the authentication information.

The managing run state of the group of the sub-service client processes centrally includes:

creating, by the client, a process state control command to control the run state of the group of the sub-service client processes centrally;

issuing, by the client, the process state control command to the group of the sub-service client processes, and receiving and executing, by the group of the sub-service client processes, the process state control command.

Preferably, the step of managing run state of the group of the sub-service client processes centrally further includes:

recording, by the client, the run state of the group of the sub-service client processes and maintaining the run state of the group of the sub-service client processes according to a recording result.

The authentication information includes a user name and a password required for the group of the sub-service client processes to log on the server, as well as process key flag information determining whether the group of the sub-service client processes is to connect to the corresponding sub-service server processes on the server automatically after the group of the sub-service client processes logs on the server.

The present invention has the following advantages over the prior art:

1. In the present invention, after the authentication information is inputted through the authentication information managing module in the process managing unit, the group of the sub-service client processes managed by the process managing unit may obtain the authentication information, pass the verifying and authenticating unit on the server, and log on the server. Therefore, the present invention avoids complex operations of inputting authentication information (such as a user name, a password, an IP address of the server, etc.) when each sub-service client process of the client logs on the server, and thereby makes the authentication of sub-service client processes transparent to the user, simplifies operations of the system and improve friendliness of the system.

2. In the present invention, the centralized process managing module controls the group of the sub-service client processes managed by the process managing unit to obtain the authentication information, pass the verifying and authenticating unit on the server with the authentication information and log on the server, thus centrally controlling the starting of the group of the sub-service client processes for obtaining the authentication information. After the group of the sub-service client processes is started, the centralized process managing module creates a process control command according to the user's instruction, and issues the process control command to the group of the sub-service client processes, so as to control the run state of the group of the sub-service client processes centrally. Therefore, the present invention utilizes the process managing unit to implement centralized management of the group of the sub-service client processes, and is advantageous to improve management and operation efficiency of the system.

### BRIEF DESCRIPTION OF THE DRAWINGS

FIG. 1 is a schematic diagram illustrating an existing information system in C/S architecture.

FIG. 2 is a schematic diagram illustrating an embodiment of a multi-service-process management system of the present invention.

FIG. 3 is a schematic construction diagram illustrating an embodiment of a process managing unit of the present invention.

FIG. 4 is a schematic construction diagram illustrating another embodiment of the process managing unit of the present invention.

FIG. 5 is a flow diagram illustrating a multi-service-process management method of the present invention.

### DETAILED DESCRIPTION OF THE EMBODIMENTS

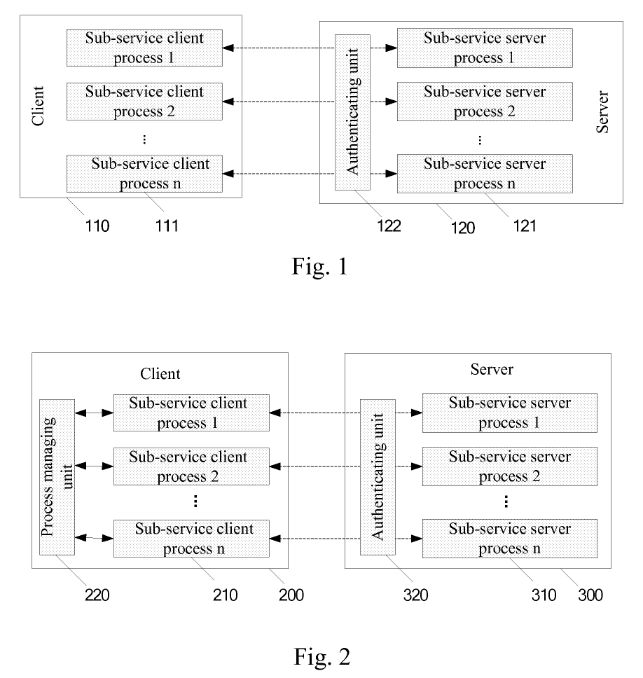

FIG. 2 shows a schematic diagram of an embodiment of a multi-service-process management system of the present invention.

The multi-service-process management system of the present invention includes a client 200 and a server 300 in C/S architecture.

The client 200 includes:

multiple sub-service client processes 210 that may operate in parallel, each of which may handle service information separately;

at least one process managing unit 220, used to manage a group of sub-service client processes 210 in the client 200 centrally.

The server 300 includes:

multiple sub-service server processes 310, each of which may operate in parallel, may handle the service information separately;

an authenticating unit 320, used to authenticate the sub-service client processes 210 that connect to the server 300 and allow the sub-service client processes 210 having passed the authentication to log on the server 300;

The sub-service client processes 210 having logged on the server 300 may connect to the sub-service server processes 310 on the server 300 corresponding to sub-service client processes 210 and communicate information with the sub-service server processes 310, so as to fully utilize the information processing advantage in C/S architecture.

The present invention intends to manage a group of sub-service client processes 210 centrally with the process managing unit 220, so as to avoid complex operations of inputting a user name, a password, an IP address of the server and the like when each of the sub-service client process 210 logs on the server 300. In addition, the present invention tends to manage the [symbol] run state of the group of the sub-service client processes 210 centrally with the process managing unit 220, so as to simplify the operations of the system and improve the operation efficiency of the system.

It is noted that although only one process managing unit 220 is shown in the client 200 in FIG. 2, the client 200 may include multiple separate process managing units 220 in practice, each of which manages a group of sub-service client processes 210. How to group the sub-service client processes 210, in other words, how to ascertain which sub-service client processes 210 a process managing unit 220 manages, may be determined according to a grouping rule defined by the user as required, so as to configure and manage the multiple sub-service client processes 210 on the client 200 by grouping.

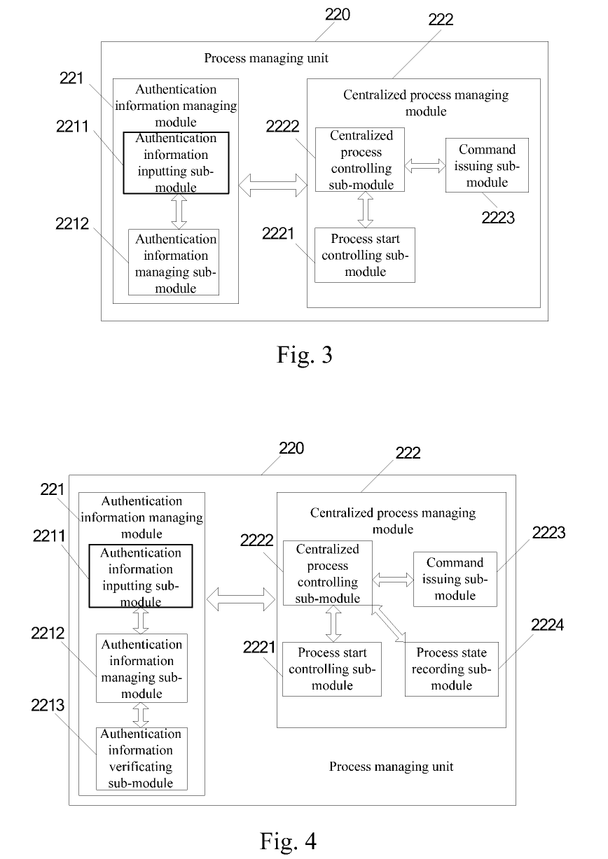

Hereunder the process managing unit 220 included on the client 200 will be further detailed with reference to the schematic construction diagram of an embodiment of the process managing unit 220 shown in FIG. 3.

The process managing unit 220 of the present invention includes:

an authentication information managing module 221, used to prompt the user to input authentication information required for the group of the sub-service client processes 210 managed by the process managing unit 220 to log on the server 300, and manage the inputted authentication information;

a centralized process managing module 222, used to control the group of the sub-service client processes 210 to obtain the inputted authentication information to log on the server 300 for carrying out the authentication; connect to the corresponding sub-service server processes 310 on the server 300; and manage the run state of the group of the sub-service client processes 210 centrally.

After the user inputs the authentication information required for the group of the sub-service client processes 210 managed by the process managing unit 220 to log on the server 300 according to the prompt of the authentication information managing module 221, the authentication information managing module 221 manages the inputted authentication information, and shares the authentication information among the group of the sub-service client processes 210 managed by the process managing unit 220 or grants the group of the sub-service client processes 210 an exclusive access right of accessing the authentication information. By this way, after the group of the sub-service client processes 210 are started by the centralized process managing module 222, each of the sub-service client process 210 may obtain the authentication information as required, utilize the authentication information to pass the authenticating unit 320 on the server 300, and then log on the server 300. Therefore, repeated operations for inputting a user name, a password and the server's IP address may be avoided.

To attain the above purpose, the authentication information managing module 221 includes:

an authentication information inputting sub-module 2211, used to prompt the user to input the authentication information required for the group of the sub-service client processes 210 managed by the process managing unit 220 to log on the server 300;

an authentication information managing sub-module 2212, used to manage the authentication information inputted from the authentication information inputting sub-module 2211, such that the authentication information may be obtained only by the group of the sub-service client processes 210.

The authentication information managing sub-module 2212 is a storage unit that may be accessed by the group of the sub-service client processes 210 exclusively or shared memory of the client 200.

The centralized process managing module 222 is used to manage the run state of the group of the sub-service client processes 210 managed by the process managing unit 220. The centralized process managing module 222 includes:

a process start controlling sub-module 2221, used to control the start of the group of the sub-service client processes 210 on the client 200, and control the group of the sub-service client processes 210 to obtain the authentication information inputted through the authentication information managing module 221 and to log on the server 300 with the authentication information;

a centralized process controlling sub-module 2222, used to create a process state control command and control the run state of the group of the sub-service client processes 210 centrally;

a command issuing sub-module 2223, used to issue the process state control command to the group of the sub-service client processes 210, such that the group of the sub-service client processes 210 may receive and execute the process state control command.

In the embodiment of the present invention, several process managing units 220 are arranged on the client 200, and each of the process managing units 220 manages a group of sub-service client processes 210 separately. The sub-service client processes 210 are transparent to the user, in other words, the user may operate the group of the sub-service client processes 210 and manage the run state of the group of the sub-service client processes 210 centrally via the process managing unit 220.

After starting the group of the sub-service client processes 210 via the process managing unit 220, the user may issue an instruction for run state such as close, log-off, lock/unlock, etc., to the process managing unit 220 as required for information processing. The centralized process controlling sub-module 2222 will create a corresponding process state control command according to the user's instruction, and the process state control command will be issued to the group of the sub-service client processes 210 by the command issuing sub-module 2223. The group of the sub-service client processes 210 receives and executes the process state control command, to change their run state as instructed by the user.

The authentication information includes a user name and a password required for the group of the sub-service client processes 210 managed by the process managing unit 220 to log on the server 300 as well as process key flag information determining whether the group of the sub-service client processes 210 is to connect to the corresponding sub-service server processes 310 on the server 300 automatically after they log on the server 300.

Configuring the process key flag information allows the user, after the group of the sub-service client processes 210 is started by the process managing unit 220, to control selectively one or several sub-service client processes 210 to log on the server 300 as required by the service instead of controlling the entire group of sub-service client process 210 to log on the server 300 without any choice, so as to take full advantage of the system resources and improve information processing efficiency of the system.

FIG. 4 shows a schematic construction diagram of another embodiment of the process managing unit 220 of the present invention.

Compared with the embodiment shown in FIG. 3, the authentication information managing module 221 in the process managing unit 220 of the embodiment shown in FIG. 4 further includes:

an authentication information verifying sub-module 2213, used to verify the authentication information by logging on the server 300 with the authentication information inputted from the authentication information inputting sub-module 2211.

The authentication information verifying sub-module 2213 is used to verify the authentication information inputted by the user, in order to ensure accuracy of the authentication information.

The centralized process managing module 222 further includes:

a process state recording sub-module 2224, used to record the run state of the group of the sub-service client processes 210, such that the centralized process controlling sub-module 2222 may maintain the run state of the group of the sub-service client processes 210 according to the recording result.

For example, the process state recording sub-module 2224 logs the run state (such as normal operation, abnormal exit, normal exit, etc.) of each of the sub-service client processes 210 managed by the process managing unit 220, respectively. The centralized process controlling sub-module 2222 controls and adjusts sub-service client processes 210 in abnormal state according to the recording result provided by the process state recording sub-module 2224, for instance, restarting a sub-service client process 210 that has exited abnormally.

The present invention also discloses a multi-service-process management method used to manage multiple service processes in C/S architecture. The method manages a group of sub-service client processes on the client centrally.

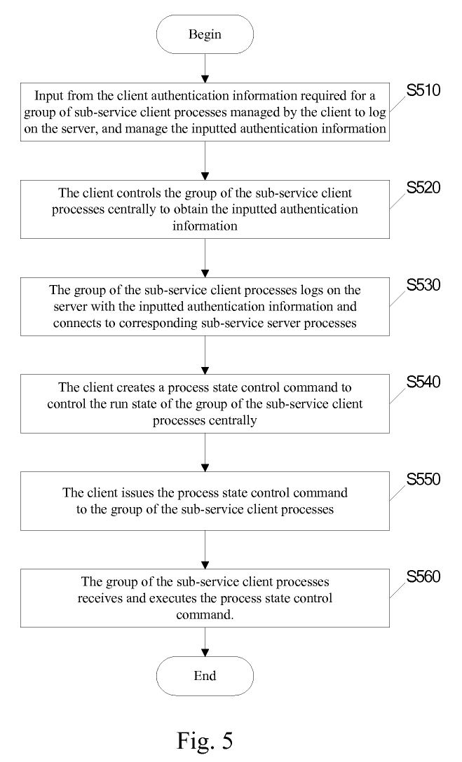

As shown in FIG. 5, the method of the present invention includes the following steps.

In step S510, authentication information required for a group of sub-service client processes managed by a client to log on a server is inputted from the client, and the client manages the inputted authentication information.

In step S520, the client controls the group of the sub-service client processes centrally to obtain the authentication information.

In step S530, the group of the sub-service client processes logs on the server by using the obtained the authentication information, and connects to corresponding sub-service server processes.

In step S540, the client creates a process state control command to control run state of the group of the sub-service client processes centrally.

In step S550, the client issues the process state control command to the group of the sub-service client processes.

In step S560, the group of the sub-service client processes receives and executes the process state control command.

The method may further include the following step after the step S510:

the client logs on the server with the inputted authentication information to verify the authentication information.

The method may further include the following step before the step S540:

the client logs the run state of the group of the sub-service client processes.

The client maintains the run state of the group of the sub-service client processes through the steps S540 to S560 according to the recording result.

The authentication information includes a user name and a password required for the group of the sub-service client processes to log on the server, as well as process key flag information determining whether the group of the sub-service client processes is to connect to the corresponding sub-service server processes automatically after they log on the server.

In conclusion, the present invention utilizes a process managing unit to manage and maintain a group of sub-service client processes on the client centrally. Therefore, the present invention has the following beneficial technical effects.

1. In the present invention, after the authentication information is inputted through the authentication information managing module in the process managing unit, the group of the sub-service client processes managed by the process managing unit may obtain the authentication information, so as to pass the verifying and authenticating unit on the server and log on the server. Therefore, the present invention avoids repeating operations of inputting authentication information (such as a user name, a password, an IP address of the server, etc.) when each sub-service client process of the client logs on the server, and thereby makes the authentication of sub-service client processes transparent to the user, simplifies operations of the system and improve friendliness of the system.

2. In the present invention, the centralized process managing module controls the group of the sub-service client processes managed by the process managing unit to obtain the authentication information, pass the verifying and authenticating unit on the server with the authentication information and log on the server, thus centrally controlling the starting of the group of the sub-service client processes for obtaining the authentication information. After the group of the sub-service client processes is started, the centralized process managing module creates a process control command according to the user's instruction, and issues the process control command to the group of the sub-service client processes, so as to control the run state of the group of the sub-service client processes centrally. Therefore, the present invention utilizes the process managing unit to implement centralized management of the group of the sub-service client processes, and is advantageous to improve management and operation efficiency of the system.

Though the present invention is described above with the preferred embodiments, it is noted that those embodiments are provided only to explain the present invention but not to limit the technical solutions of the present invention. Those skilled in the art should understand that modifications or equivalent alternatives may be made on the present invention, and any technical solutions and improvements thereof without departing from the spirit and scope of the present invention shall fall into the scope of the present invention defined by the accompanied claims.

1. A multi-service-process management system, being constructed in C/S architecture, and comprising a client having multiple sub-service client processes, and a server having multiple sub-service server processes corresponding to the multiple sub-service client processes, wherein the client comprises at least one process managing unit that manages centrally a group of sub-service client processes, and the process managing unit comprises:
an authentication information managing module, used to input authentication information required for the group of the sub-service client processes managed by the process managing unit to log on the server, and manage the authentication information;
a centralized process managing module, used to control the group of the sub-service client processes to obtain the authentication information, log on the server for carrying out authentication and connect to the corresponding sub-service server processes on the server, and manage run state of the group of the sub-service client processes centrally.

2. The multi-service-process management system according to claim 1, wherein the centralized process managing module comprises:
a process start controlling sub-module, used to control the group of the sub-service client processes to start and control the group of the sub-service client processes to obtain the authentication information and log on the server for carrying out the authentication;
a centralized process controlling sub-module, used to create a process state control command and control the run state of the group of the sub-service client processes centrally;
a command issuing sub-module, used to issue the process state control command to the group of the sub-service client processes, such that the group of the sub-service client processes may receive and execute the process state control command.

3. The multi-service-process management system according to claim 2, wherein the centralized process managing module further comprises:
a process state recording sub-module, used to record the run state of the group of the sub-service client processes, such that the centralized process controlling sub-module may maintain the run state of the group of the sub-service client processes according to a recording result.

4. The multi-service-process management system according to claim 1, wherein the authentication information managing module comprises:
an authentication information inputting sub-module, used to input the authentication information required for the group of the sub-service client processes managed by the process managing unit to log on the server;
an authentication information managing sub-module, used to manage the authentication information inputted from the authentication information inputting sub-module such that the authentication information may be obtained only by the group of the sub-service client processes.

5. The multi-service-process management system according to claim 4, wherein the authentication information managing sub-module is a storage unit that may be accessed by the group of the sub-service client processes exclusively or a shared memory of the client.

6. The multi-service-process management system according to claim 4, wherein the authentication information managing module further comprises:
an authentication information verifying sub-module, used to verify the authentication information by logging on the server with the authentication information inputted from the authentication information inputting sub-module.

7. The multi-service-process management system according to claim 1, wherein the authentication information comprises a user name and a password required for the group of the sub-service client processes managed by the process managing unit to log on the server, as well as process key flag information determining whether the group of the sub-service client processes is to connect to the corresponding sub-service server processes on the server automatically after the group of the sub-service client processes logs on the server.

8. A multi-service-process management method, for managing multiple service processes in C/S architecture, the method managing a group of sub-service client processes on a client, and comprising:
inputting from the client authentication information required for the group of the sub-service client processes managed by the client to log on a server from the client, and managing the inputted authentication information;
controlling, by the client, the group of the sub-service client processes centrally to obtain the inputted authentication information, then logging on the server for carrying out authentication, connecting to corresponding sub-service server processes on the server, and managing run state of the group of the sub-service client processes centrally.

9. The multi-service-process management method according to claim 8, wherein after inputting from the client the authentication information, the method further comprises:
logging on, by the client, the server with the inputted authentication information to verify the authentication information.

10. The multi-service-process management method according to claim 8, wherein the managing run state of the group of the sub-service client processes centrally comprises:
creating, by the client, a process state control command to control the run state of the group of the sub-service client processes centrally;
issuing, by the client, the process state control command to the group of the sub-service client processes, and receiving and executing, by the group of the sub-service client processes, the process state control command.

11. The multi-service-process management method according to claim 10, wherein the step of managing run state of the group of the sub-service client processes centrally further comprises:
recording, by the client, the run state of the group of the sub-service client processes and maintaining the run state of the group of the sub-service client processes according to a recording result.

12. The multi-service-process management method according to claim 8, wherein the authentication information comprises a user name and a password required for the group of the sub-service client processes to log on the server, as well as process key flag information determining whether the group of the sub-service client processes is to connect to the corresponding sub-service server processes on the server automatically after the group of the sub-service client processes logs on the server.
